(19) United States
(12) Patent Application Publication
(10) Pub. No.: US 2013/0075383 A1
(43) Pub. Date: Mar. 28, 2013

(54) TRANSPARENT HEATING DEVICE

(71) Applicant: Jae Hoon Kim, Seoul (KR)

(72) Inventor: Jae Hoon Kim, Seoul (KR)

(73) Assignee: SAMSUNG ELECTRO-MECHANICS CO., LTD., Gyunggi-do (KR)

(21) Appl. No.: 13/332,302

(22) Filed: Dec. 20, 2011

(30) Foreign Application Priority Data
Sep. 23, 2011 (KR) 10-2011-0096393

(51) Int. Cl. B60L 1/02

(52) U.S. Cl. 219/203

(57) ABSTRACT

Disclosed herein is a transparent heating device. The transparent heating device according to exemplary embodiments of the present invention includes a transparent heating unit disposed on one side portion of the window to generate heat so as to remove and prevent frost or condensation over the window.

### CROSS REFERENCE TO RELATED APPLICATION

This application claims the benefit of Korean Patent Application No. 10-2011-0096393, filed on Sep. 23, 2011, entitled “Transparent Heating Device”, which is hereby incorporated by reference in its entirety into this application.

### BACKGROUND OF THE INVENTION

1. Technical Field

The present invention relates to a transparent heating device.

2. Description of the Related Art

Generally, a window of a car is covered with frost due to a temperature difference inside and outside a car, which obstructs a driver's field of vision. Therefore, a car is provided with a device for removing the frost Generally, a windshield of a car is thawed by blowing hot wind onto the windshield by operating a heater of a car and a back windshield thaws by operating a heating device using a separate heat ray since it is difficult to connect a hot wind vent to the back windshield.

In this configuration, the heating device using the heat ray according to the prior art generally includes terminals each formed at both sides of a back windshield of a car, respectively, route patterns formed to extend downwardly from the terminals, and a plurality of heating patterns horizontally connecting the route patterns along the route patterns. Power applied to the heating device using the heat ray is applied from the terminals to each route pattern and from the route pattern to each heating pattern to generate heat for melting frost.

However, since the heating device using the heat ray according to the prior art is not transparent, it is difficult for a the driver to secure his/her field of vision and the aesthetics of a vehicle may be degraded in appearance when the heating device is mounted on a windshield or a side glass of a car.

In addition, the heating device using the heat ray according to the prior art cannot uniformly melt and remove the frost covering the glass since power is intensively applied to the terminals.

### SUMMARY OF THE INVENTION

The present invention has been made in an effort to provide a transparent heating device capable of removing and preventing frost or condensation of a window by generating heat.

According to a preferred embodiment of the present invention, there is provided a transparent heating device, comprising: a transparent heating unit disposed on one side portion of the window to generate heat so as to remove and prevent frost or condensation over the window.

The transparent heating unit may include a transparent heating electrode made of a metal material and formed in a mesh pattern.

The transparent heating unit may further include a transparent film having the transparent heating electrode formed on one surface or both surfaces thereof.

The transparent heating unit may further include an adhesive layer formed on one surface of the transparent film to bond the transparent film to the window.

The transparent heating electrode may be made of at least one selected from a group consisting of gold (Au), silver (Ag), aluminum (Al), copper (Cu), chromium (Cr), nickel (Ni), titanium (Ti), palladium (Pd), molybdenum (Mo), copper oxide (Cu₂O, CuO), aluminum oxide (Al₂O₃), silver oxide (AgO), chromium oxide (CrOx), titanium oxide (TiO₂), palladium oxide (PdO), and molybdenum oxide (MoO₃).

The transparent heating electrode may be formed by patterning a copper foil in a mesh pattern.

A surface of the transparent heating electrode may be subjected to black oxide.

The transparent heating unit may further include terminal electrodes formed at an edge of the transparent heating electrode.

The terminal electrode may be formed in a linear bar type.

The transparent heating electrode may be formed on the window in a plurality of columns or rows, and the terminal electrode further includes a plurality of connection terminals extendedly formed so as to be connected to each of the transparent heating electrodes formed in the plurality of columns or rows.

The transparent heating electrode may include a first transparent heating electrode and a second transparent heating electrode, and the transparent film includes a first transparent film and a second transparent film, wherein surfaces of the first transparent film and the second transparent film are each provided with the first transparent heating electrode and the second transparent heating electrode to sense a change in capacitance at the time of a touch input of a user.

The transparent heating unit may further include a first terminal electrode and a second terminal electrode each formed on surfaces of the first transparent film and the second transparent film and electrically connected to the first transparent heating electrode and the second transparent heating electrode.

### BRIEF DESCRIPTION OF THE DRAWINGS

FIG. 1 is a conceptual diagram showing a transparent heating device according to a preferred embodiment of the present invention;

FIG. 2 is a cross-sectional view taken along the line A-A′ of FIG. 1;

FIG. 3 is a conceptual diagram showing a transparent heating device according to another preferred embodiment of the present invention; and

FIG. 4 is a cross-sectional view showing a transparent heating device according to another preferred embodiment of the present invention.

### DESCRIPTION OF THE PREFERRED EMBODIMENTS

Various features and advantages of the present invention will be more obvious from the following description with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. However, the invention may be embedded in may different forms and should not be construed as limited to the embodiments set forth herein. Further, when it is determined that the detailed description of the known art related to the present invention may obscure the gist of the present invention, a detailed description thereof will be omitted.

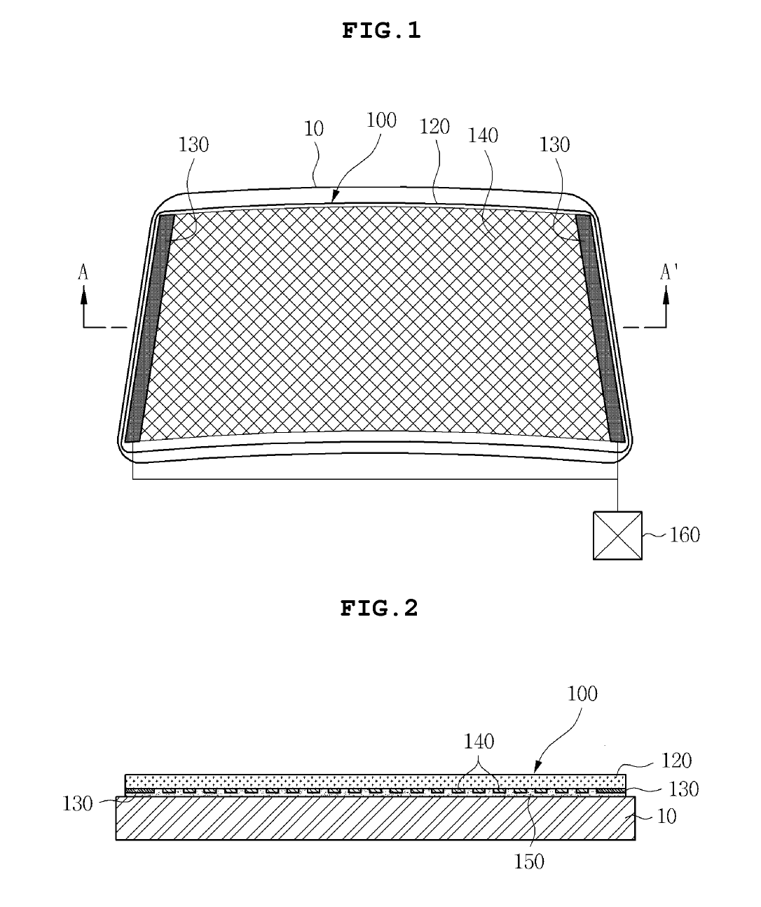

FIG. 1 is a conceptual diagram showing a transparent heating device according to a preferred embodiment of the present invention and FIG. 2 is a cross-sectional view taken along the line A-A′ of FIG. 1.

Referring to FIGS. 1 and 2, the transparent heating device according to the preferred embodiment of the present invention includes a transparent heating unit 100 disposed at one side portion of a window 10 to generate heat. In this configuration, the transparent heating unit 100 includes a transparent heating electrode 140 to remove and prevent frost or condensation formed on a surface of the window 10. In addition, the transparent heating unit 100 may further include a transparent film 120 having transparent heating electrodes 140 formed on one surface or both surfaces thereof.

Referring first to FIG. 1, the window 10 is made of glass, transparent plastic, or the like. In more detail, the window 10 may be a windshield, a back windshield, or a side glass of a car. However, the window 10 according to the preferred embodiment of the present invention is not limited thereto. For example, the window 10 may be formed of a window of a house, a mirror of a bathroom, or the like.

Referring to FIGS. 1 and 2, the transparent heating electrode 140 is made of a metal material and formed in a mesh pattern. In this case, in order to make the transparent heating electrode 140 transparent, the transparent heating electrode 140 is formed to have a line width of 7 μm or less. However, the line width of the transparent heating electrode 140 according to the preferred embodiment of the present invention is not necessarily limited to 7 μm or less.

In addition, the transparent heating electrode 140 may be formed on the transparent film 120 so as to be attached to one side portion of the window 10. However, the preferred embodiment of the present invention is not necessarily limited to a shape in which the transparent heating electrode 140 is formed on the transparent film 120. For example, the transparent heating electrode 140 may be formed on one surface or both sides of the window 10. In this configuration, the transparent heating electrode 140 may be formed over one surface or both surfaces of the window 10 or the transparent film 120.

Further, the transparent film 120 may be made of silicon. For example, the silicon may be made of any one selected from a group consisting of Polydimethylsiloxane, Polymethylhydrosiloxane, Polymethylphenylsiloxane, and Polydiphenylsiloxane.

Further, the transparent film 120 is made of silicon, such that the transparent film 120 may have a support force of predetermined strength or more to stably support the transparent heating electrode 140 and have adhesion to directly form the transparent heating electrode 140 on the transparent film 120 without additional adhesive materials. Therefore, a manufacturing process of the transparent heating device according to the preferred embodiment of the present invention may be simplified and manufacturing costs may be saved.

However, the transparent film 120 does not necessarily remove the additional adhesive material but the transparent film 120 may be subjected to primary processing so as to increase adhesion between the transparent film 120 and the transparent heating electrode 140.

However, the material of the transparent film 120 according to the preferred embodiment of the present is not necessarily limited to silicon. For example, the transparent film 120 may be made of polyethyleneterephthalate (PET), polycarbonate (PC), polymethylmethacrylate (PMMA), polyethylenenaphthalate (PEN), polyethersulfone (PES), cyclic olefin copolymer (COC), triacetylcellulose (TAC), polyvinyl alcohol (PVA), polyimide (PI), polystyrene (PS), biaxially oriented polystyrene (BOPS; containing K resin), and the like.

Meanwhile, an adhesive layer 150 may be formed on one surface of the transparent film 120 to bond the transparent film 120 to the window 10.

Further, the transparent heating electrode 140 is made of a metal material. For example, the transparent heating electrode 140 may be made of at least one selected from a group consisting of gold (Au), silver (Ag), aluminum (Al), copper (Cu), chromium (Cr), nickel (Ni), titanium (Ti), palladium (Pd), molybdenum (Mo), copper oxide (Cu₂O, CuO), aluminum oxide (Al₂O₃), silver oxide (AgO), chromium oxide (CrOx), titanium oxide (TiO₂), palladium oxide (PdO), and molybdenum oxide (MoO₃), but is not necessarily limited thereto.

In this case, the transparent heating electrode 140 may be formed by being patterned using a metal foil in a mesh pattern.

In addition, the transparent heating electrode 140 may be formed by, for example, a photoresist method, a silver salt processing method, a roll to roll method, or the like, but the method for forming the transparent heating electrode 140 is not necessarily limited thereto.

In this case, the method for forming the transparent heating electrode 140 by the photoresist method stacks the metal foil on the window 10 or the transparent film 120 and then stacks a dry film on a top portion of the metal foil. Further, when a dry film is exposed by irradiating ultraviolet rays, the dry film is selectively hardened. In addition, since the dry film is selectively hardened, a non-hardened portion of the dry film may be removed by being dissolved with a developer such as sodium cathonate (NA₂CO₃), potassium cathonate (K₂CO₃), or the like. Further, the transparent heating electrode 140 may be patterned so as to form an opening part by selectively removing the dry film. Therefore, the transparent heating electrode 140 is patterned by selectively etching the exposed metal foil through the opening part of the dry film, thereby forming the transparent heating electrode 140 made of a metal material and formed in a mesh pattern. In this case, a photoresist method forming the transparent heating electrode 140 according to a preferred embodiment of the present invention is not necessarily limited thereto.

In addition, the method for forming the transparent heating electrode 140 by the silver salt processing method applies silver salt emulsion to the window 10 or the transparent film 120 and makes selectively the metal silver remain to form a pattern when selectively exposing the silver salt emulsion, thereby forming the transparent heating electrode 140 made of a metal material and formed in a mesh pattern. In this case, the silver salt may be made of, for example, silver chloride (AgCl).

Further, the method for forming the transparent heating electrode 140 by the roll to roll method forms the transparent heating electrode 140 made of a metal material and formed in a mesh pattern by pattern-printing (direct printing technology (DPT)) silver (Ag) nano ink on the window 10 or the transparent film 120 in the mesh pattern by the screen printing, or the like.

Meanwhile, an example of the metal foil may include a copper foil. In this case, when the transparent heating electrode 140 is formed by patterning the copper foil in the mesh pattern, the surface of the transparent heating electrode 140 may be subjected to black oxide. In this case, the black oxide precipitates Cu₂O or CuO by oxidizing the surface of the transparent heating electrode (copper foil) 140, wherein Cu₂O has brown and therefore, may be called brown oxide and CuO has black and therefore, black oxide. Therefore, the surface of the transparent heating electrode 140 is subjected to the black oxide, such that the reflection of light from the transparent heating electrode 140 may be prevented. As a result, the visibility of the transparent heat device 100 may be improved.

Referring to FIGS. 1 and 2, the transparent heating unit 110 includes a terminal electrode 130 electrically connected to an edge of the transparent heating electrode 140. In this configuration, the terminal electrode 130 may be integrally formed with the transparent heating electrode 140 using the same component.

However, this is by way example only. The terminal electrode 130 may be separately printed from the transparent heating electrode 140 by using a screen printing method, a gravure printing method, an inkjet printing method, or the like. In this case, as the material of the terminal electrode 130 may use a material composed of silver paste (Ag paste) or organic silver having excellent electric conductivity. Meanwhile, the terminal electrode 130 is connected to both ends of the transparent heating electrode 140 in the drawings, which is by way of example only. The terminal electrode 130 may be connected to only one end of the transparent heating electrode 140.

In this case, the terminal electrode 130 is electrically connected to the edge of the transparent heating electrode 140 to supply electricity to the transparent heating electrode 140. In this case, the terminal electrode 130 may be formed in a pair having rectangular linear bar type and may be disposed on both sides of the transparent heating electrode 140. However, the type and position of the terminal electrode 130 according to the preferred embodiment of the present invention are not limited thereto. In addition, the terminal electrode 130 may receive electricity through a power controller 160 including a power supply unit and a switch.

Hereinafter, the operation of the transparent heat device according to the preferred embodiment of the present invention will be described.

Referring to FIG. 1, for example, in order to remove or prevent frost or condensation formed on the surface of the window 10 of the car by using the transparent heat device, electricity is supplied to the transparent heating electrode 140 through the terminal electrode 130 when electricity is supplied to the terminal electrode 130 from the power controller 160.

Therefore, resistance heat generated from the transparent heating electrode 140 may melt and remove the frost formed over the surface of the window 10 or may remove the condensation formed thereover.

In this case, the transparent heating electrode 140 is made of a metal material and formed in a mesh pattern while having a line width of 7 μm or less to secure transparency, thereby securing a driver's field of vision.

In addition, the transparent heating electrode 140 is formed over the window 10 to uniformly melt and remove the frost formed over the surface of the window 10 or remove the condensation thereover.

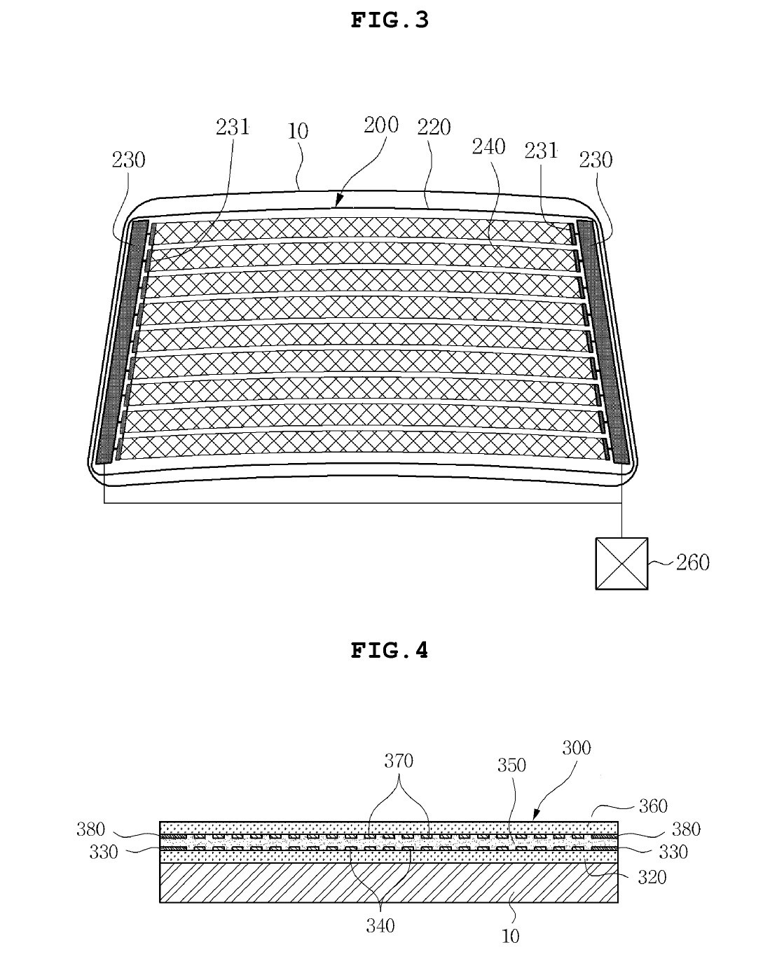

FIG. 3 is a conceptual diagram showing a transparent heat device according to another preferred embodiment of the present invention.

In describing the transparent heat device according to another preferred embodiment of the present invention, the detailed description of the same components as the preferred embodiment shown FIGS. 1 and 2 will be omitted and therefore, the description of the transparent heat device according to another preferred embodiment of the present invention will be mainly describe with reference to discriminated components.

Referring to FIG. 3, in the transparent heat device according to another preferred embodiment of the present invention, the transparent heating unit 200 includes a transparent heating electrode 240 and terminal electrodes 230 connected to the transparent heating electrode 240, wherein the terminal electrode 230 is connected to both sides of an edge of the transparent heating electrode 240.

In this configuration, a plurality of the transparent heating electrodes 240 are formed on the window 10 or the transparent film 220. In this case, the transparent heating electrodes 240 may be patterned in a plurality of columns or rows while being spaced at an interval of a predetermined height but the patterning type of the transparent heating electrode 240 according to the preferred embodiment of the present invention is not necessarily limited to the plurality of columns or rows.

In addition, a plurality of connection terminals 231 are extendedly formed so that the terminal electrodes 230 are each connected to both sides of edges of the plurality of patterned transparent heating electrodes 240. As a result, electricity supplied to the terminal electrode 230 through the power controller 260 may be transferred to each of the plurality of transparent heating electrodes 240 through the plurality of connection terminals 231.

Further, the resistance heat generated from the transparent heating electrode 240 patterned in the plurality of columns or rows of the window 10 or the transparent film 220 attached to the window 10 may remove and prevent frost or condensation formed on the window 10. In this case, the transparent heating electrode 240 is patterned only on a portion selected by the window 10 or the transparent film 220 to reduce electricity consumption for removing and preventing the frost or the condensation of the window 10.

FIG. 4 is a cross-sectional view showing a transparent heat device according to another preferred embodiment of the present invention.

In describing the transparent heat device according to another preferred embodiment of the present invention, the detailed description of the same components as the preferred embodiment shown FIGS. 1 and 2 and another preferred embodiment shown in FIG. 3 will be omitted and therefore, the description of the transparent heat device according to another preferred embodiment of the present invention will be mainly describe with reference to differentiated components.

Referring to FIG. 4, a transparent heat device according to another preferred embodiment of the present invention includes a transparent heating unit 300 disposed on one side portion of the window 10 to generate heat. In this configuration, the transparent heating unit 300 includes the transparent heating electrode and the transparent heating electrode is configured to include a first transparent heating electrode 340 and a second transparent heating electrode 370. In addition, the transparent heating unit 300 further includes a transparent film on which the transparent heating electrode is formed, wherein the transparent film is configured to include a first transparent film 320 and a second transparent film 360.

In this configuration, the first transparent heating electrode 340 and the second transparent heating electrode 370 are made of a metal material and formed in a mesh pattern and are each formed on surfaces of the first transparent film 320 and the second transparent film 360. However, the first transparent heating electrode 340 and the second transparent heating electrode 370 according to another preferred embodiment of the present invention are formed on the first transparent film 320 and the second transparent film 360 but the preferred embodiment of the present invention is not limited thereto. For example, the first transparent heating electrode 340 and the second transparent heating electrode 370 may be formed on both surfaces of the window 10.

Further, a top side of the first transparent film 320 is patterned with the first transparent heating electrode 340 and a bottom side of the second transparent film 360 may be patterned with the second transparent heating electrode 370.

Further, the first terminal electrode 330 and the second terminal electrode 380 supplying electricity to the first transparent heating electrode 340 and the second transparent heating electrode 370 are each formed on the first transparent film 320 and the second transparent film 360.

In this case, the first terminal electrode 330 is electrically connected to the first transparent heating electrode 340 and the second terminal electrode 380 is electrically connected to the second transparent heating electrode 370.

Therefore, when electricity is supplied to each of the first transparent heating electrode 340 or the second transparent heating electrode 370 through the first terminal electrode 330 or the second terminal electrode 380, the resistance heat generated from the first transparent heating electrode 340 or the first transparent heating electrode 340 may melt and remove the frost formed over the surface of the window 10 or remove the condensation formed thereover.

Meanwhile, the first transparent heating electrode 340 and the second transparent heating electrode 370 are each configured to include a driving electrode and a sensing electrode to sense a change in capacitance at the time of a touch input of a user. In this case, the second transparent heating electrode 370 that is the sensing electrode generates the signals when the input unit is touched to serve to allow the power controller 160 (see FIG. 1) including a controller to recognize the touched coordinates. In this case, the second terminal electrode 380 may receive electrical signals from the second transparent heating electrode 370 that is the sensing electrode.

Further, a spacer 350 is formed between the first transparent film 320 and the second transparent film 360 on which the first transparent heating electrode 340 and the second transparent heating electrode 370 are formed. In this case, the spacer 350 serves to insulate the first transparent heating electrode 340 and the second transparent heating electrode 370 on each transparent film from each other while bonding the first transparent film 320 and the second transparent film 360 to each other. In this case, a material of the spacer 350 is not particularly limited. For example, an optical clear adhesive (OCA) having both of insulation and adhesion may be used.

Further, the adhesive layer (not shown) is formed on the bottom side of the first transparent film 320 to easily bond the transparent heat device 300 according to the preferred embodiment of the present invention to the window 10.

Meanwhile, a transparent display is formed on any one of the first transparent film 320 or the second transparent film 360, thereby displaying images.

As set forth above, the preferred embodiment of the present invention can easily secure a field of vision by transparently forming the device removing and preventing the frost or the condensation of the window by generating heat.

Although the preferred embodiments of the present invention have been disclosed for illustrative purposes, they are for specifically explaining the present invention and thus the transparent heating device according to the present invention is not limited thereto, but those skilled in the art will appreciate that various modifications, additions and substitutions are possible, without departing from the scope and spirit of the invention as disclosed in the accompanying claims.

Accordingly, such modifications, additions and substitutions should also be understood to fall within the scope of the present invention.

What is claimed is:

1. A transparent heating device, comprising a transparent heating unit disposed on one side portion of the window to generate heat so as to remove and prevent frost or condensation over the window

2. The transparent heating device as set forth in claim 1, wherein the transparent heating unit includes a transparent heating electrode made of a metal material and formed in a mesh pattern.

3. The transparent heating device as set forth in claim 2, wherein the transparent heating unit further includes a transparent film having the transparent heating electrode formed on one surface or both surfaces thereof.

4. The transparent heating device as set forth in claim 3, wherein the transparent heating unit further includes an adhesive layer formed on one surface of the transparent film to bond the transparent film to the window.

5. The transparent heating device as set forth in claim 2, wherein the transparent heating electrode is made of at least one selected from a group consisting of gold (Au), silver (Ag), aluminum (Al), copper (Cu), chromium (Cr), nickel (Ni), titanium (Ti), palladium (Pd), molybdenum (Mo), copper oxide (Cu₂O, CuO), aluminum oxide (Al₂O₃), silver oxide (AgO), chromium oxide (CrOx), titanium oxide (TiO₂), palladium oxide (PdO), and molybdenum oxide (MoO₃).

6. The transparent heating device as set forth in claim 2, wherein the transparent heating electrode is formed by patterning a copper foil in a mesh pattern.

7. The transparent heating device as set forth in claim 6, wherein a surface of the transparent heating electrode is subjected to black oxide.

8. The transparent heating device as set forth in claim 2, wherein the transparent heating unit further includes terminal electrodes formed at an edge of the transparent heating electrode.

9. The transparent heating device as set forth in claim 8, wherein the terminal electrode is formed in a linear bar type.

10. The transparent heating device as set forth in claim 8, wherein the transparent heating electrode is formed on the window in a plurality of columns or rows, and
the terminal electrode further includes a plurality of connection terminals extendedly formed so as to be connected to each of the transparent heating electrodes formed in the plurality of columns or rows.

11. The transparent heating device as set forth in claim 3, wherein the transparent heating electrode includes a first transparent heating electrode and a second transparent heating electrode, and
the transparent film includes a first transparent film and a second transparent film,
surfaces of the first transparent film and the second transparent film each being provided with the first transparent heating electrode and the second transparent heating electrode to sense a change in capacitance at the time of a touch input of a user.

12. The transparent heating device as set forth in claim 11, wherein the transparent heating unit further includes a first terminal electrode; and a second terminal electrode each formed on surfaces of the first transparent film and the second transparent film and electrically connected to the first transparent heating electrode and the second transparent heating electrode.
